(19) United States
(12) Patent Application Publication
(10) Pub. No.: US 2009/0104108 A1
(43) Pub. Date: Apr. 23, 2009

(54) Method of Preparing Boehmite and Gamma-Alumina With High Surface Area

(76) Inventors: Ki-Won Jun, Daejeon (KR); Yun-Jo Lee, Daejeon (KR); Seung-Moon Kim, Daejeon (KR); Jeong Yeon Kim, Daejeon (KR)

Correspondence Address: FROMMER LAWRENCE & HAUG, 745 FIFTH AVENUE- 10TH FL., NEW YORK, NY, 10151, US

(21) Appl. No.: 11/886,367

(22) PCT Filed: Jan. 25, 2006
(86) PCT No.: PCT/KR2006/000291

§ 371 Date: Sep. 14, 2007

(30) Foreign Application Priority Data
Mar. 23, 2005 (KR) 10-2005-0024251

(51) Int. Cl. C01F 7/06

(52) U.S. Cl. 423/626

(57) ABSTRACT

The present invention relates to a method for preparing boehmite and γ-alumina with high surface area, and more particularly, to a method comprising hydrolysis of aluminum alkoxides to produce boehmite and calcination to produce γ-alumina, wherein an alcohol is used as a reaction solvent and a small amount of water and a particular organic carboxylic acid are added so that not only the reaction solvent is easily recovered and energy required for drying is significantly reduced but also it provides boehmite having nano-sized particles, high surface area, and high purity. Further, the prepared γ-alumina may be suitable for high value added industrial applications such as manufacture of adsorbents, catalysts, catalyst supports and chromatography materials.

This is a 371 of PCT/KR2006/000291 filed Jan. 25, 2006, published on Sep. 28, 2006 under publication number WO 2006/101305 and claims priority benefits of Korean Patent Application No. 10-2005-0024251 filed Mar. 23, 2005, the disclosure of which is hereby incorporated by reference.

### TECHNICAL FIELD

The present invention relates to a method for preparing boehmite and γ-alumina with high surface area. More particularly, the present invention relates to a method comprising hydrolysis of aluminum alkoxides to produce boehmite and calcination of the resultant to produce γ-alumina, wherein an alcohol is used as a reaction solvent and a small amount of water and a particular organic carboxylic acid are added to recover the reaction solvent easily while significantly reducing the energy required for drying and also producing nano-sized boehmite with high surface area and high purity. Further, thus prepared γ-alumina may be suitable for the industries of the production of high value added products such as adsorbents, catalysts, catalyst supports and chromatography.

### BACKGROUND

Generally, aluminum hydroxide is prepared by ‘Bayer’ method which comprises dissolving kaolin in sodium hydroxide under high pressure and high temperature, leaching aluminum oxide into the solution, and producing aluminum hydroxide by hydrolysis of the leached solution.

However, the aluminum hydroxide prepared by the Bayer method contains a considerable amount of impurities including Na₂O, Fe₂O₃, etc. Further, it is quite costly to use as an active alumina because kaolin is an imported material and also inconvenient because there incurs an additional cost to set up an autoclave which is required to maintain high pressure and high temperature during the dissolution of the ore.

Another typical method for preparing alumina having high purity is an aluminum hydrolysis which comprises hydrolysis of aluminum alkoxide to obtain alumina gel and calcinations of the resulting alumina gel to alumina as shown in reaction equations 1, 2 and 3 below. Referring to the reaction equation 1, amorphous aluminum hydroxide is prepared by the hydrolysis of aluminum alkoxide, and then boehmite is prepared by crystallization as shown in the reaction equation 2. The boehmite is then calcined at 400-800° C. to produce γ-alumina as shown in the reaction equation 3.

Al(OR)₃+3H₂O→Al(OH)₃+3ROH Reaction Equation 1

Al(OH)₃→AlOOH+H₂O Reaction Equation 2

AlOOH→½Al₂O₃+½H₂O Reaction Equation 3

Gamma-alumina is prepared by hydrolysis of aluminum alkoxide performed in the presence of an acid such as hydrochloric acid or nitric acid, followed by peptization, aging and crystal growth to produce nano-sized boehmite particles and then drying and calcining the boehmite. Here, it is known that the size of boehmite particles can be adjusted depending on reaction temperature, reaction time, amount of acid used, etc. (KR Patent No. 267722) and the size of boehmite particles can greatly influence surface area and porosity of γ-alumina prepared from the boehmite as well as those of boehmite particles.

Further, examples using an organic solvent, instead of an aqueous solution, in the hydrolysis of aluminum alkoxide are disclosed. Aluminum alkoxide 5-50 vol. % is dissolved in one chosen from ether, ketone, aldehyde and a mixture thereof and water 1-50 vol. % (H₂O:Al(OR)₃=1.5-4:1) is added to the aluminum alkoxide solution. The solution is filtered and the filtrate is dried and calcined at 200-600° C. to produce amorphous alumina having a high surface area of 300-600 m²/g (U.S. Pat. No. 4,275,052). Aluminum alkoxide is dissolved in secondary or tertiary alcohol at a high temperature of 200-300° C. to produce alumina having a high surface area of higher than 500 m²/g and aluminum isobutoxide is pyrolized in n-butanol (U.S. Pat. No. 4,387,085). Aluminum alkoxide is hydrolyzed with a small amount of water (H₂O:Al=3:1) without using any solvent and dried to produce alumina powder which is further added into an aqueous nitric acid solution of HNO₃/Al=0.27 to produce viscous sol at 100° C. and dried to obtain clear gel (U.S. Pat. No. 4,532,072)

In addition, alumina alkoxide produced as an intermediate from Ziegler/Alfol process is hydrolyzed in an aqueous solution at 60-100° C. to provide alumina suspension containing 10-11% of aluminum hydroxide. The slurry is aged in a pressure reactor at a temperature of 100-235° C. and a pressure of 1-3 for from 30 min to 20 hrs while stirring and then spray dried and calcined to provide alumina (U.S. Pat. No. 5,055,019)

As described above, when boehmite and γ-alumina are produced by hydrolysis of aluminum alkoxide in an aqueous solution, it is difficult to recover alcohol, requires high drying cost, and the alumina has poor specific surface area or porosity. Further, when an organic solvent is used for the hydrolysis, the surface area of alumina becomes rather large but it is disadvantageous in that it requires a high pressure reactor and also the product is amorphous.

### SUMMARY OF THE INVENTION

The inventors of the present invention have therefore made efforts to resolve drawbacks present in the conventional method of manufacturing boehmite and γ-alumina in the presence of aqueous and organic solvents such as low porosity and surface area, inefficiency of processability, etc.

As a result, they have completed the present invention by manufacturing boehmite prepared via peptization by adding a small amount of water, an adequate amount of a particular organic carboxylic acid and using an alcohol as a reaction solvent in the preparation of boehmite via hydrolysis of aluminum alkoxide, thereby not necessitating separation and recovery of the aluminum alkoxide, while significantly reducing energy consumption as compared to the conventional method using water as a reaction solvent, Besides, the resulted nano-sized product has high surface area and high purity.

Further, γ-alumina prepared by calcinations of the boehmite has also high surface area and high purity which can be therefore suitable for catalyst grade.

Therefore, in an embodiment of the present invention, there is provided nano-sized boehmite particles with high surface area and high purity.

In another embodiment of the present invention, there is provided a method for preparing γ-alumina by utilizing the boehmite to be suitable for adsorbents, catalysts, catalyst supports, chromatography, etc.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a graph illustrating X-Ray Diffraction patterns of boehmites with high surface area prepared in Examples 1 to 5 according to the present invention;

FIG. 2 is a graph illustrating X-Ray Diffraction patterns of boehmites with high surface area prepared in Comparative Examples 1 to 2;

FIG. 3 is a graph illustrating X-Ray Diffraction pattern of γ-alumina prepared by calcination (at 600° C. for 6 hrs) of boehmite prepared in Example 1 according to the present invention;

FIG. 4 is a picture of nano-sized boehmite particles dispersed in water (A) which is prepared in Example 2 according to the present invention and boehmite dispersed in water (B) which is prepared in Comparative Example 1; and

FIG. 5 shows electron microscopic images of nano-sized boehmite particles (A) prepared in Example 1 according to the present invention and agglomerated particles of boehmite (B) which is prepared in Comparative Example 1.

### DETAILED DESCRIPTION OF THE INVENTION

As stated above, in an embodiment of the present invention, there is provided a method for preparing boehmite having high surface area comprising:

preparing an aluminum alkoxide solution by dissolving aluminum alkoxide in an alcohol solvent at a temperature of 80-130° C.;

preparing boehmite sol by adding 0.01-1 mol of an organic carboxylic acid having a pKa value of 3.5-5 and 2-12 mol of water based on 1 mol of the aluminum alkoxide solution into the aluminum alkoxide solution and heating the mixture at 80-130° C. for 1-48 hrs; and

preparing boehmite powder and separating/recovering the alcohol solvent by distilling the boehmite sol and drying.

In a further embodiment of the present invention, there is provided a method for preparing γ-alumina having high surface area by calcination of the boehmite prepared according to the present invention.

The invention is described in more detail hereinafter.

In the preparation of boehmite by hydrolyzing aluminum alkoxide as well as in the preparation of γ-alumina by calcination of the boehmite, a solvent used in the present invention is an alcohol having the same type as the aluminum alkoxide. Further, a small amount of water and an organic carboxylic acid are also added in the hydrolysis process for easy recovery of the solvent and drying at a low temperature which significantly reduces energy consumption. The present invention describes a method for preparing boehmite which has a particle size of 3-30 nm and a relatively high specific surface area as compared to that prepared by the conventional method and γ-alumina by calcination of the boehmite.

Each process for preparing boehmite and γ-alumina having high surface area is described in detail as follows.

Aluminum alkoxide is prepared by dissolving aluminum alkoxide in a C₁-C₄ alcohol.

Generally, the hydrolysis of aluminum alkoxide is performed in an aqueous medium but there are some drawbacks/difficulty in recovering alcohol produced from the alkoxide and drying the alumina in the aqueous solution due to the requirement of more energy and of agglomeration of nano-sized alumina particles during drying process due to the capillary tube pressure, thus rendering difficulty in forming meso- or macro-pores and deteriorating performance when it is used as a catalyst or an adsorbent.

However, when alcohol, which has less capillary tube pressure than water, is used as a solvent, a cohesive force between nano-particles becomes much lower thus generating aluminas having meso- or macro-pores. Therefore, the important feature of the present invention lies in using alcohol as a solvent and an optimal amount of water necessary for hydrolysis of aluminum alkoxide and peptization and crystallization of boehmite from amorphous aluminum hydroxide.

The alcohol used as a reaction solvent in the present invention has carbon atoms of from 1 to 4 and has a boiling temperature of below 150° C. The examples of the alcohol include methanol, ethanol, 1-propanol, 2-propanol, 1-butanol, 2-butanol and 2-methyl propanol. Such an alcohol is used in the range of from 5 to 200 mol based on 1 mol of the aluminum alkoxide. If the mol ratio is less than 5, it is difficult to dissolve aluminum alkoxide in alcohol. In contrast, if it is higher than 200, it deteriorates reaction efficiency and cost-effectiveness.

Here, the reaction temperature is in the range of from 80 to 130° C. When the temperature is lower than 80° C., a crystal growth rate becomes slow and aluminum hydroxide such as gibbsite is formed as an impurity and when it is higher than 130° C., boehmite crystal grows too much.

An organic carboxylic acid of 0.01-1 mol and water are added into the aluminum alkoxide solution and heated to produce boehmite sol. Here, rapid hydrolysis is carried out with the added water and white amorphous aluminum hydroxide formed therefrom is dissolved in alcohol. The peptization is carried out with the organic acid, resulting in boehmite sol having a nano-size.

Particle size and crystallinity of the boehmite sol vary in accordance with a kind of acid used, the amount used, and reaction temperature. The organic carboxylic acid used in the present invention is a weak acid having a pKa of 3.5 to 5. Examples of the organic carboxylic acid include formic acid, acetic acid and propionic acid. The organic carboxylic acid is used in the range of from 0.01 to 1 mol based on 1 mol of aluminum alkoxide, preferably from 0.01 to 0.5. If it is used less than 0.01 mol, it is negligible and thus would not affect the reaction. The increase in the amount of acid used results in decrease in the crystalline size of boehmite particles and the resulting sol becomes clearer. That is, aluminum hydroxide produced from the hydrolysis of the aluminum alkoxide is rapidly peptized with the increase in the amount of acid, resulting in increase in the number of crystalline cores of boehmite and decease in its particle size. Thus, the particle size of boehmite is controlled easily with the amount of acid to be used and physical properties such as specific surface area, porosity, etc. of the boehmite are also easily controlled. However, when the organic carboxylic acid is used more than 1 mol, it combines with aluminum and forms aluminum tricarboxylate. Such organic carboxylic acids can be easily removed even at a relatively low drying temperature and it allows to obtain desired boehmite without deforming its structure or crystallinity so that it is preferable to use an organic acid than an inorganic acid.

An optimal amount of water in the range of from 2 to 12 mol based on 1 mol of aluminum alkoxide is used in the hydrolysis. If it is used less than 2 mol, the amount is too little to affect the hydrolysis reaction. However, if it exceeds to be more than 12 mol, excess of water is used thereby making it difficult to dry and recover solvent therefrom.

The reaction is performed at a temperature of 80 to 130° C. for 1 to 48 hrs. When the temperature is lower than 80° C., a crystal growth rate becomes slow and aluminum hydroxide such as gibbsite is formed as an impurity. In contrast, when it is higher than 130° C., boehmite crystal grows too much. If the reaction time is performed for less than 1 hr, it is not enough to form boehmite crystals. In contrast, when it is performed for more than 48 hrs, it deteriorates reaction and economical efficiencies.

The boehmite sol is then distilled and dried to produce boehmite powder while recovering alcohol solvent. Drying method is not limited but any known method to one skilled in the art may be performed, for example, vacuum dry, spray dry. The drying temperature is preferred to be in the range of 50 to 300° C. Such a drying condition requires a lower temperature than the temperature to dry water so that use of alcohol as a solvent is more advantageous in terms of cost and reaction efficiency. Thus recovered alcohol used as a solvent and produced from the hydrolysis reaction can be reused for further reactions since it does not contain water and also has high purity.

The boehmite powder prepared according to the above process has a particle size of 3-30 nm and significantly improved specific surface area and porosity compared to that when water is used as a solvent.

Gamma-alumina is prepared by a typical method of calcining the prepared boehmite at a temperature of 400-800° C. Thus prepared γ-alumina has a specific surface area of 300-500 m²/g, high porosity and high purity not containing any impurities such as Na₂O so that it can be used for preparing catalyst supports, catalysts, adsorbents, and in chromatography.

The present invention will be described in further detail by way of the following examples, however, they should not be construed as limiting the scope of the present invention.

### EXAMPLES

### Example 1

Aluminum isopropoxide (10 g) was added to 2-propanol (73.5 g) and stirred. The mixture was then heated to 82.4° C., the boiling point of 2-propanol, and then refluxed. Here, the aluminum isopropoxide mixture became a clear slurry. Acetic acid (0.29 g) and water (5.26 g) were added to the slurry to perform hydrolysis and produced amorphous aluminum hydroxide as a result. The aluminum hydroxide was then peptized and crystallized by refluxing for 20 hrs. Here, the mol ratio of reactants of aluminum isopropoxide:2-propanol:acetic acid:water was 1:25:0.1:6. The boehmite sol was dried at 70° C. under vacuum for 12 hrs to produce boehmite powder and the 2-propanol was recovered during the above process by installing a liquid nitrogen trap.

Thus recovered boehmite powder was calcined at 600° C. for 6 hrs to produce γ-alumina.

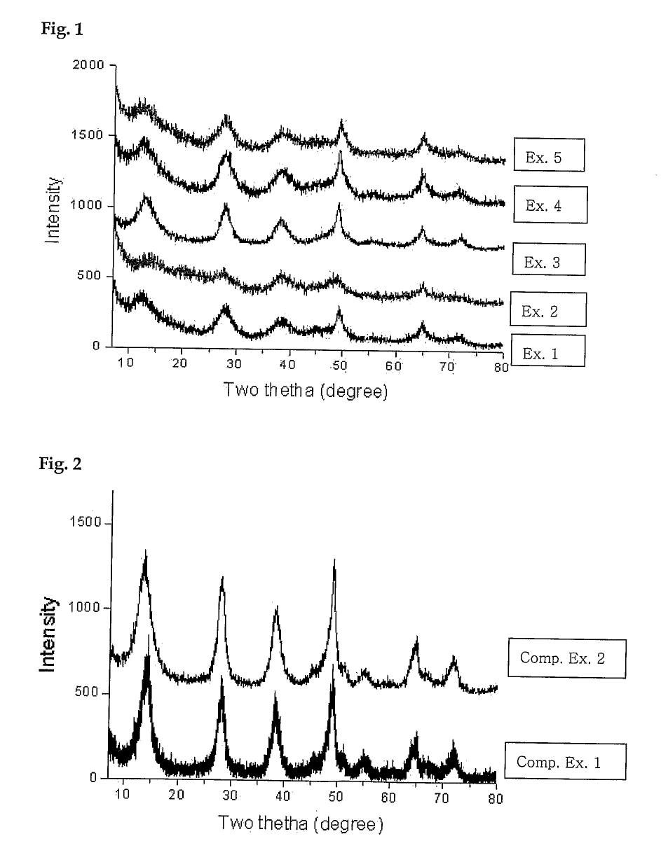

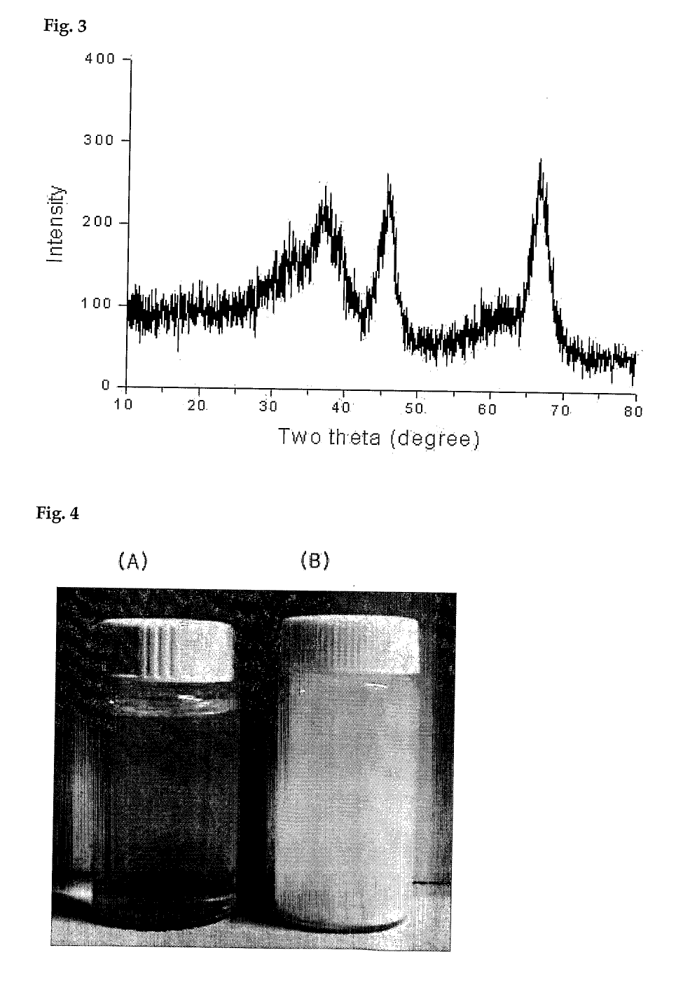

BET surface area and pore volume of the boehmite and γ-alumina were determined by nitrogen gas adsorption and the result is summarized in Table 1. FIG. 1 and FIG. 3 respectively show X-ray diffraction patterns of the boehmite and γ-alumina.

### Example 2

Experiments were performed same as in Example 1 to produce the boehmite and γ-alumina, except that acetic acid (1.47 g) and water (5.29 g) were used and the mol ratio of aluminum isopropoxide:2-propanol:acetic acid:water was 1:25:0.5:6.

BET surface area and pore volume of the boehmite and γ-alumina were determined by nitrogen gas adsorption and the result is summarized in Table 1. FIG. 1 shows the X-ray diffraction pattern of the boehmite.

### Example 3

Experiments were performed same as in Example 1 to produce the boehmite and γ-alumina, except that acetic acid (0.1 g) and water (5.29 g) were used and the mol ratio of aluminum isopropoxide:2-propanol:acetic acid:water was 1:25:0.035:6.

BET surface area and pore volume of the boehmite and γ-alumina were determined by nitrogen gas adsorption and the result is summarized in Table 1. FIG. 1 shows the X-ray diffraction pattern of the boehmite.

### Example 4

Experiments were performed same as in Example 1 to produce the boehmite and γ-alumina, except that acetic acid (0.1 g) and water (2.65 g) were used and the mol ratio of aluminum isopropoxide:2-propanol:acetic acid:water was 1:25:0.035:3.

BET surface area and pore volume of the boehmite and γ-alumina were determined by nitrogen gas adsorption and the result is summarized in Table 1. FIG. 1 shows the X-ray diffraction pattern of the boehmite.

### Example 5

Experiments were performed same as in Example 1 to produce the boehmite and γ-alumina, except that 2-propanol was used twice the amount used in Example 1 and the mol ratio of aluminum isopropoxide:2-propanol:acetic acid:water was 1:50:0.1:6.

BET surface area and pore volume of the boehmite and γ-alumina were determined by nitrogen gas adsorption and the result is summarized in Table 1. FIG. 1 shows the X-ray diffraction pattern of the boehmite.

### Comparative Example 1

Experiments were performed same as in Example 1 to produce the boehmite and γ-alumina, except that water (44.0 g) was used instead of 2-propanol and 60% nitric acid (0.51 g) instead of acetic acid. Aluminum isopropoxide was added in a solution of water and nitric acid and heated at reflux. The mol ratio of aluminum isopropoxide:nitric acid:water was 1:0.1:50.

BET surface area and pore volume of the boehmite and γ-alumina were determined by nitrogen gas adsorption and the result is summarized in Table 1. FIG. 2 shows the X-ray diffraction pattern of the boehmite.

### Comparative Example 2

Experiments were performed same as in Example 1 to produce the boehmite and γ-alumina, except that acetic acid was not used and the mol ratio of aluminum isopropoxide:2-propanol:water was 1:25:6.

BET surface area and pore volume of the boehmite and γ-alumina were determined by nitrogen gas adsorption and the result is summarized in Table 1. FIG. 2 shows the X-ray diffraction pattern of the boehmite.

The table 1 provides the BET nitrogen gas adsorption analysis result of each of boehmite and γ-alumina prepared in Examples 1-5 and Comparative Examples 1-2.

TABLE 1

| | boehmite | | γ-alumina | |
|---|---|---|---|---|
| | specific | Pore | specific | Pore |
| | surface area | volume | surface area | volume |
| Category | (m²/g) | (cc/g) | (m²/g) | (cc/g) |
| Example 1 | 491 | 1.08 | 343 | 1.10 |
| Example 2 | 629 | 0.70 | 360 | 0.76 |
| Example 3 | 401 | 1.25 | 354 | 1.45 |
| Example 4 | 748 | 1.19 | 463 | 1.22 |
| Example 5 | 473 | 0.96 | 321 | 1.01 |
| Comparative | 267 | 0.22 | 216 | 0.44 |
| Example 1 | | | | |
| Comparative | 314 | 1.25 | 278 | 1.25 |
| Example 2 | | | | |

From the XRD analysis, it was confirmed that pure boehmite and γ-alumina were formed from Examples 1-5 and Comparative Examples 1-2. As shown in FIG. 1 of XRD pattern of the boehmite having nano-sized particles prepared from Examples 1-5, typical peaks of boehmite appeared at 2θ=13.9°, 27.8°, 38.3°, 49.3°, 65.2°, and 72.1°. These peaks were smaller in height but wider in width than those of boehmite crystalline particles prepared from Comparative Examples 1-2 which means that the nano-sized crystalline particles of the boehmite from Examples 1-5 are smaller than those obtained from Comparative Examples 1-2. It was also noted that the particle size of boehmite powder became smaller when it was dispersed in water. That is, when the boehmite prepared from Examples 1-5 was dispersed in water, it became a clear sol as seen in FIG. 4A while the boehmite prepared from Comparative Examples 1-2 showed high turbidity when dispersed in water because they look cloudy by light scattering due to their relatively bigger particle size.

According to FIG. 3 of XRD pattern of γ-alumina prepared by calcination of the boehmite from Example 1 at 600° C. for 6 hrs, it was noted that peaks appeared at 2θ=38°, 45°, 67°, which are typical with γ-alumina.

Table 1 exhibits the BET nitrogen gas adsorption analysis result of each boehmite and γ-alumina prepared in Examples 1-5 and Comparative Examples 1-2. As shown in Table 1, it is noted that when boehmite is produced from aluminum alkoxide, the boehmites prepared from Examples 1-5, in which 2-propanol was used as a solvent, exhibit improved BET specific surface areas and pore volumes compared to the boehmites prepared from Comparative Examples 1-2, in which water was used.

The specific surface area has increased up to more than 2 folds (267→748 m²/g) and pore volume was increased up to 5 folds (0.22→1.25 cc/g), compared to those when water was used as a solvent. In case that 2-propanol was used as a solvent, as the amount of acetic acid increased, the specific surface area increased while the pore volume decreased. When boehmite was produced by hydrolysis and peptization, a number of crystal cores of boehmite increased as the amount of acetic acid increased and thus the particle size became smaller, thus resulting in increase in specific surface area but decrease in pore volume. Such results were observed when water was used a as a solvent. But when alcohol evaporated, capillary tube pressure became lower than that when water evaporated since the surface tension of alcohol was less than water, so that agglomeration between particles became less and thus pore volume became larger.

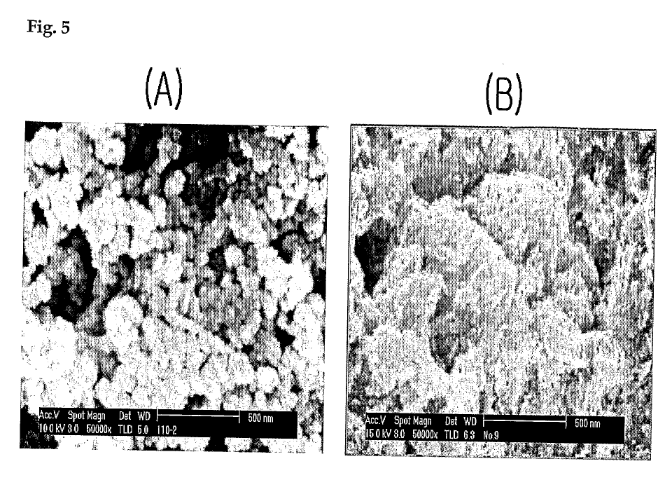

It is noted as shown in FIGS. 4 and 5 that nano-particles of the boehmite prepared by using alcohol as a solvent do not agglomerate with each other. FIG. 4 shows a picture illustrating dispersion of boehmite powder in water. As shown in FIG. 4, it was noted that the boehmite prepared by using alcohol as a solvent and acetic acid and a small amount of water was well dispersed in water to form a clear sol which can be also noticed in FIG. 5.

On the other hand, as shown FIG. 4B, boehmite prepared by using water as a solvent as in Comparative Example 1 was not well dispersed but became agglomerated hard, which is also noticed in FIG. 5B.

The boehmite prepared by using alcohol as a solvent but not using organic carboxylic acid as in Comparative Example 2 shows that the pore volume was not decreased but specific surface area was significantly reduced as compared to those prepared in Examples 1-5. This is because the number of crystal cores is less and thus the particle size of boehmite becomes larger.

### INDUSTRIAL APPLICABILITY

As stated above, in the preparation of boehmite and γ-alumina from aluminum alkoxide according to the present invention, alcohol was used as a solvent, a particular organic acid as a peptizing agent, and an optimal amount of water as a reactant thereby providing several advantages of less energy consumption, easy recovery and reuse of alcohol and improved specific surface area and porosity.

In addition, the present invention is also advantageous in that any remaining acid can be easily removed by heating, provides a rather wider scope of preparation conditions are as compared to the conventional method using an inorganic acid.

Further, the product obtained from the present invention has improved specific surface area and porosity without containing any impurities thus being suitable for high value-added industrial applications such as manufacture of adsorbents, catalysts, catalyst supports and chromatography materials.

Those skilled in the art will appreciate that the conceptions and specific embodiments disclosed in the foregoing description may be readily utilized as a basis for modifying or designing other embodiments for carrying out the same purposes of the present invention.

What is claimed is:

1. A method for preparing boehmite having high surface area comprising:
(a) preparing an aluminum alkoxide solution by dissolving aluminum alkoxide in an alcohol solvent at a temperature of 80-130° C.;
(b) preparing boehmite sol by adding 0.01-1 mol of an organic carboxylic acid having a pKa value of 3.5-5 and 2-12 mol of water based on 1 mol of said aluminum alkoxide solution into said aluminum alkoxide solution and heating the mixture at 80-130° C. for 1-48 hrs; and
(c) preparing boehmite powder and separating/recovering said alcohol solvent by distilling said boehmite sol followed by drying.

2. A method for preparing γ-alumina high surface area comprising:
(a) preparing an aluminum alkoxide solution by dissolving aluminum alkoxide in an alcohol solvent at a temperature of 80-130° C.;
(b) preparing boehmite sol by adding 0.01-1 mol of an organic carboxylic acid having a pKa value of 3.5-5 and 2-12 mol of water based on 1 mol of the aluminum alkoxide solution into said aluminum alkoxide solution and heating the mixture at 80-130° C. for 1-48 hrs;
(c) preparing boehmite powder and separating/recovering said alcohol solvent by distilling said boehmite sol followed by drying; and
(d) calcining said boehmite at a temperature of 400-700° C. for 1-96 hrs.

3. The method of claim 1, wherein said alcohol is selected from the group consisting of alcohols having from 1 to 4 carbon atoms including methanol, ethanol, 1-propanol, 2-propanol, 1-butanol, 2-butanol and 2-methyl propanol.

4. The method of claim 1, wherein said alcohol is used in the range of from 5 to 200 mol based on 1 mol of said aluminum alkoxide.

5. The method of claim 1, wherein said organic carboxylic acid is selected from the group consisting of formic acid, acetic acid, and propionic acid.

6. The method of claim 2, wherein said alcohol is selected from the group consisting of alcohols having from 1 to 4 carbon atoms including methanol, ethanol, 1-propanol, 2-propanol, 1-butanol, 2-butanol and 2-methyl propanol.

7. The method of claim 2, wherein said alcohol is used in the range of from 5 to 200 mol based on 1 mol of said aluminum alkoxide.

8. The method of claim 2, wherein said organic carboxylic acid is selected from the group consisting of formic acid, acetic acid, and propionic acid.
